(19) United States
(12) Patent Application Publication
(10) Pub. No.: US 2021/0276171 A1
(43) Pub. Date: Sep. 9, 2021

(54) ELECTRIC NAIL GUN WITH BUFFER MECHANISM

(71) Applicant: BASSO INDUSTRY CORPORATION, Taichung City (TW)

(72) Inventors: Chun-Chi LAI, Taichung City (TW); Chien-An LIU, Taichung City (TW)

(73) Assignee: BASSO INDUSTRY CORPORATION, Taichung City (TW)

(21) Appl. No.: 17/190,842

(22) Filed: Mar. 3, 2021

(30) Foreign Application Priority Data
Mar. 4, 2020 (TW) 109107080

(51) Int. Cl. B25C 1/06

(52) U.S. Cl. CPC B25C 1/06

(57) ABSTRACT

An electric nail gun with a buffer mechanism is provided and includes a frame, a weight assembly provided on a side of the frame and having a weight frame, an impact assembly provided in the frame and having an impact frame, a transmission assembly for interlocking the weight assembly and the impact assembly, and a buffer component, where the transmission assembly has a first rack interlocked with the impact frame, a second rack interlocked with the weight assembly, and a gear unit meshed with the first rack and the second rack. The buffer component is provided between the first rack and the impact frame, so that buffering is achieved by reducing a counter force generated when the impact frame collides with the frame to prevent the first rack, the second rack, and the gear unit from being damaged due to the counter force.

### CROSS REFERENCE TO RELATED APPLICATION

This application claims priority to and the benefit of Taiwanese Application No. 109107080, filed Mar. 4, 2020, the entirety of which is incorporated by reference herein.

### BACKGROUND

### Technical Field

The present disclosure relates to an electric nail gun, and more particularly, to an electric nail gun with a buffer mechanism.

### Description of Related Art

When performing woodworking, nails are often used to secure a workpiece such as a wooden board. In the early days, tools such as hammers are used. However, hammers are inefficient and laborious. If care is not taken, nails may become skew that may not look good nor provide enough fastening; it can even lead to injury of a user's body. As a result, electric nail guns have emerged to allow woodworking to be performed more efficiently and effortlessly. An impact assembly in an electric nail gun can be actuated electrically to strike a nail into a workpiece. It allows nails to be driven into the desired locations continuously and quickly with good accuracy. As such, the electrical nail guns can be adopted easily even by the nonprofessionals.

However, an electric nail gun disclosed in U.S. Pat. No. 10,363,650 describes that a large counter force may be created during striking by an impact assembly. This large counter force may cause damage to the internal components of the electric nail gun, and thus a buffer structure has to be provided in the electric nail gun to absorb the counter force generated during operation. In view of this, an elastic structure was proposed to be provided on a gear set used for creating the impact force in an electric nail gun to provide an elastic buffer effect and lessen any damage caused by the counter force. However, the gear set of the electric nail gun is small in size, drilling a hole into the gear set and assemble the elastic structure thereon may be challenging. Furthermore, it may also reduce the overall structural strength of the gears. Thus, there is still room for improvements in the above approach.

Therefore, there is a need for a buffer structure for an electric nail gun that provides easy assembly as well as a buffer mechanism when the electric nail gun is being used without adversely affecting the structural strength of the gear set in the electric nail gun.

### SUMMARY

In view of the aforementioned shortcomings of the prior art, the present disclosure provides an electric nail gun with a buffer mechanism, which includes: a frame including a front end and a back end opposite to each other; a weight assembly disposed on a side of the frame, wherein the weight assembly includes a weight frame that is movable between the front end and the back end; an impact assembly disposed in the frame, wherein the impact assembly includes an impact frame that is movable between the front end and the back end; a transmission assembly disposed on a side of the frame and including a first rack interlocked with the impact frame, a second rack connected with the weight frame, and a gear unit meshed with the first rack and the second rack; and a buffer component disposed between the impact frame and the first rack.

In an embodiment, the impact frame is formed with a concave slot, and the first rack includes a protruded portion that meshes with the concave slot, such that the impact frame is interlocked with the first rack.

In another embodiment, the buffer component is disposed between the protruded portion and a sidewall of the concave slot.

In another embodiment, the buffer component is provided on a side of the protruded portion facing the sidewall, or on the sidewall of the concave slot.

In another embodiment, the buffer component further includes a coupling piece disposed on the impact frame and an elastic piece disposed on the coupling piece.

In another embodiment, the coupling piece includes a recess, and the elastic piece is formed into an L shape inside the recess.

In another embodiment, the gear unit includes a large gear and a small gear coaxially provided and interlocked with each other, wherein the large gear is meshed with the first rack, and the small gear is meshed with the second rack.

In another embodiment, the large gear and the small gear are integrally formed.

In another embodiment, the large gear includes at least one first slot, the small gear includes at least one second slot corresponding to the at least one first slot, and the gear unit further includes at least one connecting piece disposed in the respective at least one first slot and the respective at least one second slot, such that the large gear and the small gear are interlocked through the at least one connecting piece.

In another embodiment, the at least one first slot and the at least one second slot are curved slots, and the at least one connecting piece is a curved piece.

In another embodiment, there are gaps formed between the at least one connecting piece and the at least one first slot, the at least one second slot, or both.

In another embodiment, the at least one connecting piece is made of an elastic material.

In summary of the above, in the electric nail gun with a buffer mechanism in accordance with the present disclosure, the buffer component provided between the first rack and the impact frame provides a buffer, so that when a counter force generated from the impact frame in collision with the front end of the frame, the first rack, the second rack, and the gear unit of the transmission assembly can be prevented from damage due to the counter force. In addition, the impact assembly can be a one-piece structure or a composite structure having a coupling piece and an elastic piece depending on the need. Furthermore, the large and small gears in the gear unit of the transmission assembly can also be configured to include an elastic connecting piece to further alleviate the influence of the counter force. Therefore, the electric nail gun with a buffer mechanism in accordance with the present disclosure is capable of reducing structural damage caused by the impact and conducive to extending the service life of the electric nail gun.

### BRIEF DESCRIPTION OF THE DRAWINGS

FIG. 1 is a perspective structural diagram depicting a top view of a portion of components of an electric nail gun with a buffer mechanism in accordance with the present disclosure.

FIG. 2 is a perspective structural diagram depicting a bottom view of a portion of components of the electric nail gun with a buffer mechanism in accordance with the present disclosure.

FIG. 3 is a side view depicting a portion of components of the electric nail gun with a buffer mechanism in accordance with the present disclosure.

FIG. 4A is a perspective structural diagram depicting a buffer component provided between an impact frame and a first rack in accordance with the present disclosure.

FIG. 4B is a perspective structural diagram depicting an additional buffer component in accordance with the present disclosure.

FIG. 5A is a perspective structural exploded diagram depicting another embodiment of the buffer component in the electric nail gun with a buffer mechanism in accordance with the present disclosure.

FIG. 5B is a perspective structural diagram depicting the another embodiment of the buffer component in the electric nail gun with a buffer mechanism in accordance with the present disclosure after assembly.

FIG. 6A is a perspective structural diagram depicting a gear unit in an electric nail gun with a buffer mechanism in accordance with the present disclosure.

FIG. 6B is a perspective structural exploded diagram depicting another embodiment of the gear unit in the electric nail gun with a buffer mechanism in accordance with the present disclosure.

FIG. 7 is a structural schematic diagram depicting an electric nail gun with a buffer mechanism in accordance with the present disclosure.

### DETAILED DESCRIPTION

The following describes the implementation of the present disclosure by specific embodiments, and those skilled in the art can easily understand other advantages and effects of the present disclosure based on the contents disclosed in this specification, or implement or apply the present disclosure based on other different specific embodiments.

It should be noted that the structures, ratios, sizes shown in the appended drawings are to be construed in conjunction with the disclosures herein in order to facilitate understanding of those skilled in the art. They are not meant, in any way, to limit the implementations of the present disclosure, and therefore contain no substantial technical meaning. Without influencing the effects created and the objectives achieved by the present disclosure, any modifications, changes or adjustments to the structures, ratios or sizes should fall within the scope encompassed by the technical contents disclosed herein. Meanwhile, terms such as “above,” “first,” “side,” and the like, are for illustrative purposes, and are not meant to limit the scope in which the present disclosure can be implemented. Any variations or modifications made to their relative relationships, without changing the substantial technical contents, are also to be construed as within the scope of the present disclosure.

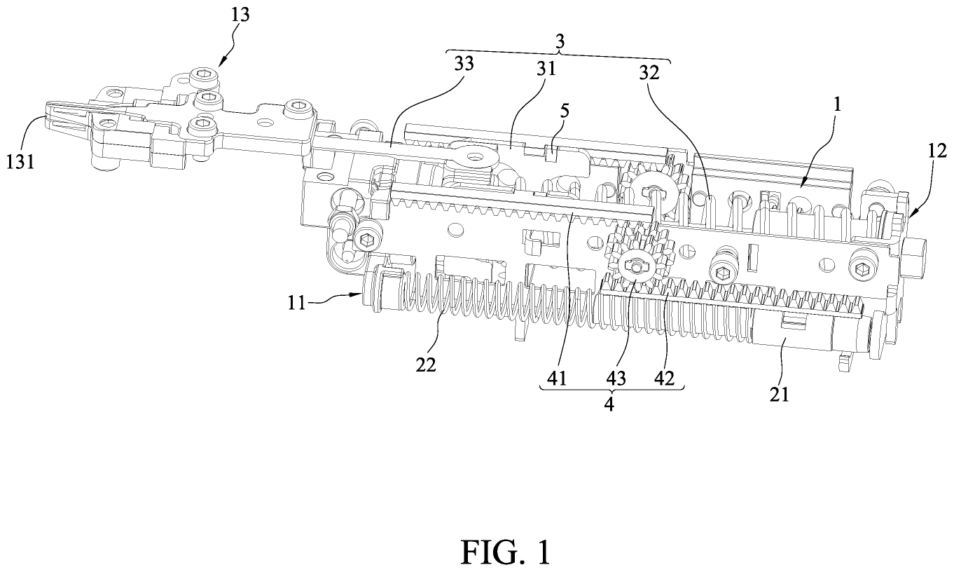

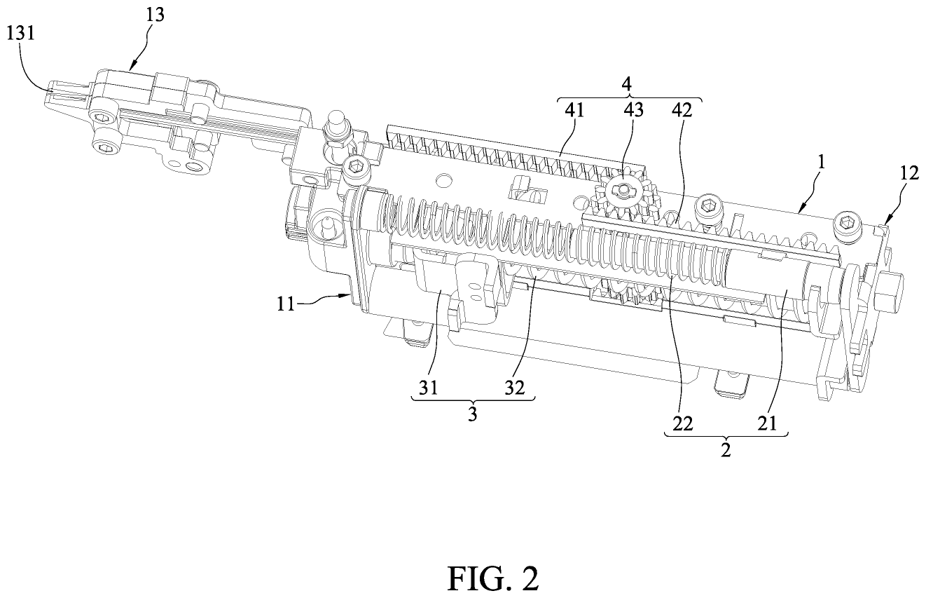

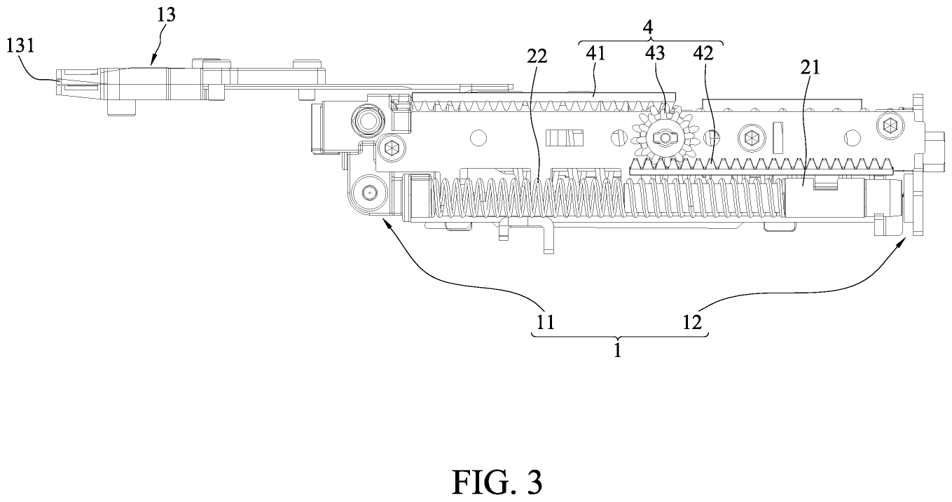

FIG. 1 is a perspective structural diagram depicting a top view of a portion of components of an electric nail gun with a buffer mechanism in accordance with the present disclosure; FIG. 2 is a perspective structural diagram depicting a bottom view of a portion of components of the electric nail gun with a buffer mechanism in accordance with the present disclosure; and FIG. 3 is a side view depicting a portion of components of the electric nail gun with a buffer mechanism in accordance with the present disclosure. As shown in FIGS. 1-3, the electric nail gun with a buffer mechanism in accordance with the present disclosure includes a frame 1, a weight assembly 2, an impact assembly 3, a transmission assembly 4 and a buffer component 5, wherein the weight assembly 2 and the impact assembly 3 are installed on or in the frame 1. The weight assembly 2 and the impact assembly 3 are interlocked through the transmission assembly 4 provided on the frame 1 between the weight assembly 2 and the impact assembly 3. The buffer component 5 is disposed between the impact assembly 3 and the transmission assembly 4, for example, at a junction of the two, so as to absorb a counter force generated by the impact assembly 3 during operation of the electric nail gun. The above structures of the present disclosure are further described in detail below. It should also be noted that similar structures are provided on two sides of the frame, so components are described in quantities of two in the following descriptions.

The frame 1 is assembled into a housing (not shown) of the electric nail gun to allow the weight assembly 2, the impact assembly 3 and the transmission assembly 4 to be assembled therein or on the outer sides thereof. The frame 1 has a front end 11 and a back end 12 opposite to each other, and a nose 13 provided at the front end 11 and having a nail ejection exit 131, wherein a direction extending outwardly from the front end 11 via the nose 13 of the electric nail gun is the direction along which nails are ejected.

The weight assembly 2 includes two weight frames 21 disposed on either side of the frame 1 and can be displaced between the front end 11 and the back end 12 of the frame 1, and a weight spring 22 disposed between each of the weight frame 21 and the front end 11 of the frame 1. The weight spring 22 can be compressed or released in accordance with the movements of the respective weight frame 21.

The impact assembly 3 is housed in the frame 1 and includes an impact frame 31 that is movable between the front end 11 and the back end 12 of the frame 1, an impact spring 32 disposed between the impact frame 31 and the back end 12 of the frame 1, and a firing pin 33 connected with the impact frame 31 and corresponding to the nail ejection exit 131 by extending into the nose 13 via the front end 11 of the frame 1. When the impact frame 31 moves between the front end 11 and the back end 12 of the frame 1, the firing pin 33 is caused to move back and forth within the nose 13. Accordingly, during an operation of the electric nail gun, the impact frame 31 is first lifted towards the back end 12 of the frame 1, which compresses the impact spring 32 and retracts the firing pin 33 backwards, such that when the impact spring 32 is released, the elastic force of the impact spring 32 thrusts the impact frame 31 forwards towards the front end 11 of the frame 1 and provides an impact force. As a result, the firing pin 33 connected with the impact frame 31 strikes a nail forwards with the impact force, allowing the nail to be ejected out of the nail ejection exit 131 of the electric nail gun.

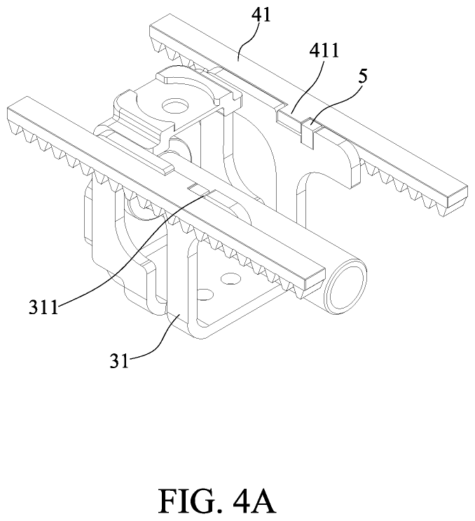

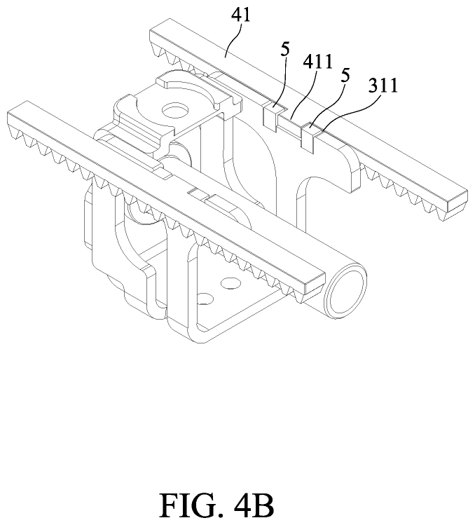

In an embodiment, as shown in FIG. 4A, which is a perspective structural diagram depicting a buffer component provided between an impact frame and a first rack in accordance with the present disclosure, the impact frame 31 of the impact assembly 3 includes a base and two side portions extending from two sides of the base with a concave slot 311 formed at the top of the respective side portion. Each side portion is disposed on each of the two sides of the frame 1, and moves back and forth between the front end 11 and the back end 12 of the frame 1.

The transmission assembly 4 includes two first racks 41, two second racks 42 and two gear units 43. In other words, each of the two sides of the frame 1 includes a set of a first rack 41, a second rack 42 and a gear unit 43. Each set of the first rack 41, the second rack 42 and the gear unit 43 is disposed at a side outside the frame 1, wherein the first rack 41 and the second rack 42 of the same set are disposed at the top end and the bottom end on the same side of the frame 1, respectively, and are interconnected and linked with the impact frame 31 and the weight frame 21, respectively. The gear unit 43 is disposed on the frame 1 and meshed with the first rack 41 and the second rack 42. Accordingly, during the process in which the impact frame 31 is being lifted from the front end 11 to the back end 12 of the frame 1, the gear unit 43 is driven into a rotation by the first rack 41 linked with the impact frame 31, which in turn moves the second rack 42 linked with the gear unit 43, thereby pushing the weight frame 21 forwards from the back end 12 to the front end 11 of the frame 1. In effect, when the impact frame 31 is lifted to the back end 12 of the frame 1, the weight frame 21 is pushed and moved to the front end 11 of the frame 1.

As shown in FIG. 4A, each first rack 41 has a protruded portion 411, which protrudes into and engaging with the respective concave slot 311, such that the first rack 41 and the impact frame 31 are interlocked.

The buffer component 5 is disposed between the impact frame 31 and the first rack 41, for example, at a location where the two components are connected. In an embodiment, in order to reduce the influence of the impact, the buffer component 5 can be a structure made of an elastic material. More specifically, as shown in FIG. 4A, the buffer component 5 is disposed in the concave slot 311 of a respective impact frame 31, and when the protruded portion 411 of the first rack 41 and the concave slot 311 of the impact frame 31 are assembled together, the buffer component 5 is located between the protruded portion 411 and a side wall of the concave slot 311. Preferably, the buffer component 5 is disposed between the protruded portion 411 and the rear side wall (closer to the back end 12 of the frame 1) of the concave slot 311. As a result, during the process in which the impact frame 31 is being lifted, the front side wall (closer to the front end 11 of the frame 1) of the concave slot 311 rigidly pushes against the protruded portion 411. On the other hand, when the impact frame 31 thrusts towards the front end 11 of the frame 1 and impinges on the front end 11 of the frame 1, a counter force is created and the impact frame 31 is then pushed backwards onto the protruded portion 411 of the first rack 41. Meanwhile, the buffer component 5 positioned between the concave slot 311 and the protruded portion 411 can provide an elastic buffer effect to prevent damages occurring between the first rack 41 and the gear unit 43 as well as between the gear unit 43 and the second rack 42 as a result of the collision of the impact frame 31 upon the first rack 41.

In addition, as shown in FIG. 4B, which is a perspective structural diagram depicting an additional buffer component in accordance with the present disclosure, another buffer component 5 can be added between the protruded portion 411 of the first rack 41 and the front side wall of the concave slot 311 of the impact frame 31 to provide additional buffer effect.

In an embodiment, the buffer component 5 can be secured onto the protruded portion 411, that is, the buffer component 5 can be provided on one or two sides of the protruded portion 411 facing the sidewall(s) of the concave slot 311. Alternatively, the buffer component 5 can be secured onto the front side wall and/or the rear side wall of the concave slot 311.

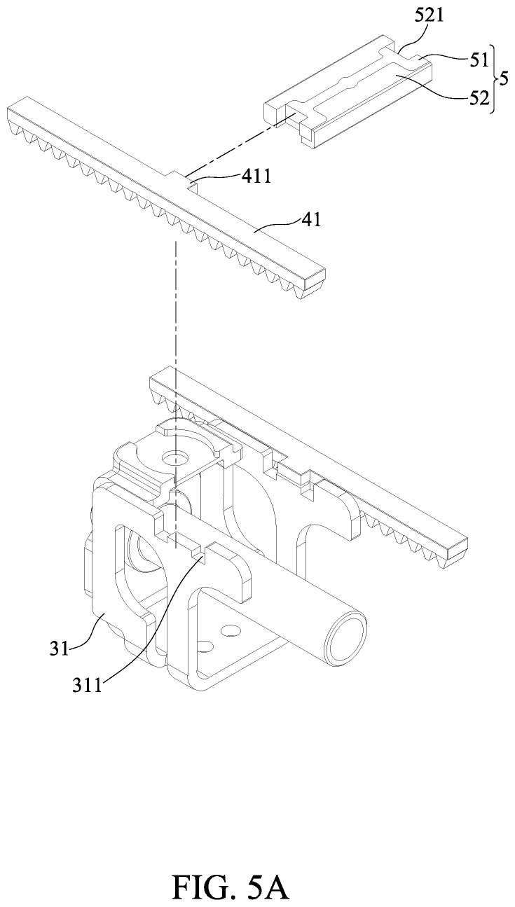

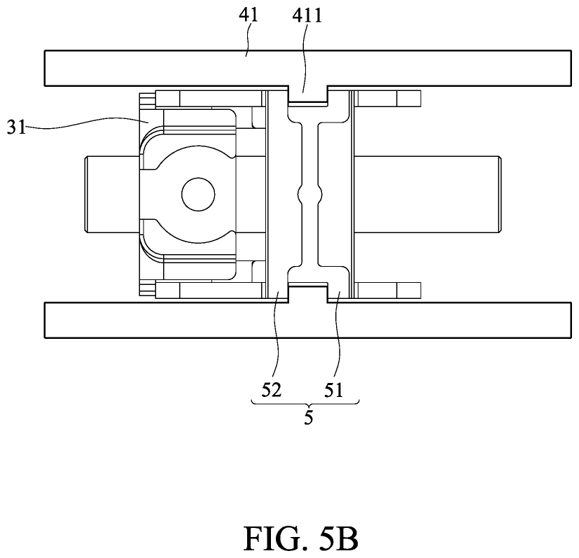

In another embodiment, as shown in FIGS. 5A and 5B, which are perspective structural exploded diagram and perspective structural diagram depicting another embodiment of the buffer component in the electric nail gun with a buffer mechanism in accordance with the present disclosure, respectively. As shown, the buffer component 5 includes a coupling piece 52 provided on the impact frame 31 and elastic pieces 51 provided on the coupling piece 52. The elastic pieces 51 can be disposed at two ends of the coupling piece 52, spanning across the impact frame 31 by the coupling piece 52 and between the concave slots 311 in the two sides of the impact frame 31. The elastic pieces 51 can be disposed between the protruded portions 411 of the first racks 41 and the rear side walls of the concave slots 311 of the impact frame 31. Preferably, recesses 521 are formed at two ends of the coupling piece 52, and each elastic piece 51 is formed into an “L” shape, such that each L-shaped elastic piece 51 is disposed in the respective recess 521. In other words, the elastic piece 51 extends from the bottom of the respective recess 521 towards a side thereof, covering portions of the recess 521.

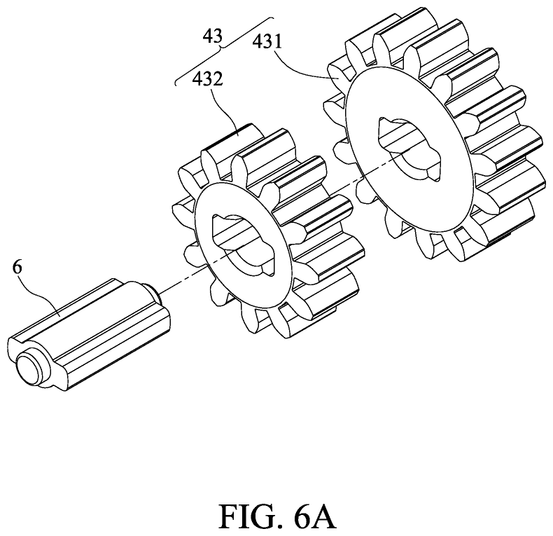

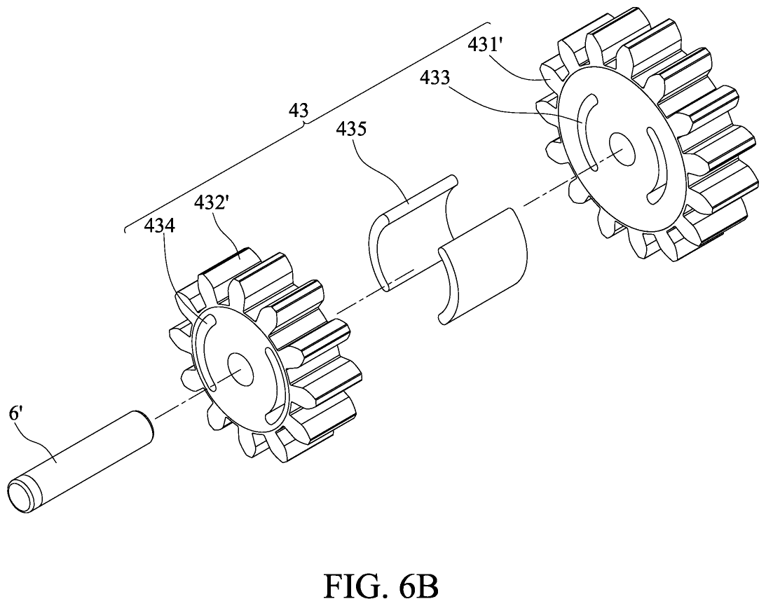

In an embodiment, as shown in FIG. 6A, which is a perspective structural diagram depicting a gear unit in an electric nail gun with a buffer mechanism in accordance with the present disclosure, in conjunction with FIG. 1, the gear unit 43 includes large gear 431 and small gear 432 that are coaxially provided and interlocked by an axle 6. The large gear 431 meshes with the first rack 41, while the small gear 432 meshes with the second rack 42. In an embodiment, the large gear 431 and the small gear 432 are integrally formed into one structure.

In another embodiment, as shown in FIG. 6B, which is a perspective structural exploded diagram depicting another embodiment of the gear unit in the electric nail gun with a buffer mechanism in accordance with the present disclosure, the large gear 431′ and the small gear 432′ are pivotally connected using the axle 6′, wherein the large gear 431′ has at least one first slot 433, and the small gear 432′ has at least one second slot 434 corresponding to the at least one first slot 433. The gear unit 43 further includes at least one connecting piece 435, which is inserted into the respective first slot 433 and the respective second slot 434, such that the large gear 431′ and the small gear 432′ are interlocked through the connecting piece 435.

In another embodiment, the first slot 433 and the second slot 434 are curved slots, and the connecting piece 435 is a curved piece corresponding to the large gear 431 and the second slot 434. In addition, the length of the connecting piece 435 along the circumferential direction of the gear is slighter smaller than those of the first slot 433 and the second slot 434, so that there are gaps between the connecting piece 435 and the two sides of the first slot 433 and the second slot 434 when the connecting piece 435 is provided in the first slot 433 and the second slot 434. As such, the large gear 431′ and the small gear 432′ can be interlocked through the connecting piece 435. Moreover, the connecting piece 435 can be made of an elastic material, so as to provide additional buffer effect when the large gear 431′ and the small gear 432′ are interlocked.

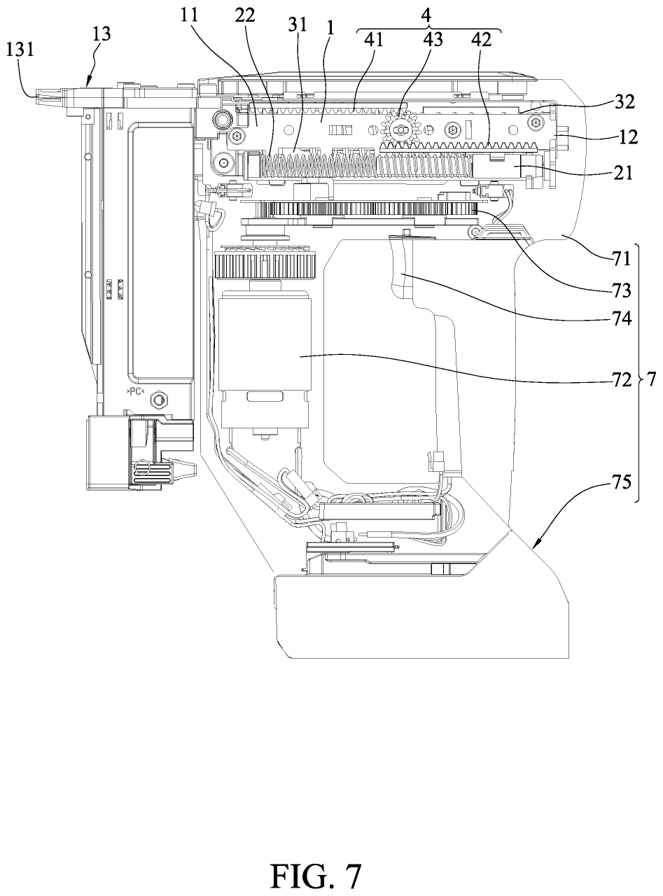

FIG. 7 is a structural schematic diagram depicting an electric nail gun with a buffer mechanism in accordance with the present disclosure. As shown, an electric nail gun 7 includes a housing 71, a power unit 72 received in the housing 71, a driving unit 73 received in the housing 71 and connected with the power unit 72, a trigger 74 provided at a handle of the housing 71 and electrically connected with and controls the power unit 72, and a power supply 75 received in the housing 71 for supplying power to the power unit 72. The buffer mechanism described above is received in the housing 71. As shown in the upper half of the diagram, the impact frame 31 is powered by the driving unit 73, such that when the driving unit 73 is actuated by the power unit 72, the impact frame 31 is lifted by the driving unit 73 to move towards the back end 12 of the frame 1 and the impact spring 32 is compressed, meanwhile, the gear unit 43 rotates as a result of the first rack 41 being displaced by the impact frame 31, which in turns moves the second rack 42 and shifts the weight frame 21 linked with the second rack 42 towards the front end 11 of the frame 1, thereby compressing the weight spring 22. On the other hand, when the impact frame 31 impinges on the front end 11 of the frame 1 due to the restoring force of the impact spring 32, the weight frame 21 will be pushed towards the back end 12 of the frame 1 in order to balance the inertia of the impact frame 31 moving forwards by the restoring force. Accordingly, in the present disclosure, the impact frame 31 is lifted to the back end 12 of the frame 1 by a force, and then returned to the front end 11 of the frame 1 to complete one operating cycle. With the impact force brought about by the impact frame 31 returned to the front end 11, the firing pin 33 will strike in the nose 13 towards the nail ejection exit 131, and a nail stored in the electric nail gun and entering the nose 13 will be ejected outside when struck by the firing pin 33.

The above embodiments are set forth to illustrate the principles of the present disclosure, and should not be interpreted as to limit the present disclosure in any way. The above embodiments can be modified by one of ordinary skill in the art without departing from the scope of the present disclosure as defined in the appended claims.

What is claimed is:

1. An electric nail gun having a buffer mechanism, comprising:
a frame including a front end and a back end opposite to each other;
a weight assembly disposed on a side of the frame, wherein the weight assembly includes a weight frame that is movable between the front end and the back end;
an impact assembly disposed in the frame, wherein the impact assembly includes an impact frame that is movable between the front end and the back end;
a transmission assembly disposed on a side of the frame and including a first rack interlocked with the impact frame, a second rack connected with the weight frame, and a gear unit meshed with the first rack and the second rack; and
a buffer component disposed between the impact frame and the first rack.

2. The electric nail gun of claim 1, wherein the impact frame is formed with a concave slot, and the first rack includes a protruded portion that meshes with the concave slot, such that the impact frame is interlocked with the first rack.

3. The electric nail gun of claim 2, wherein the buffer component is disposed between the protruded portion and a sidewall of the concave slot.

4. The electric nail gun of claim 3, wherein the buffer component is provided on a side of the protruded portion facing the sidewall, or on the sidewall of the concave slot.

5. The electric nail gun of claim 2, wherein the buffer component further includes a coupling piece disposed on the impact frame and an elastic piece disposed on the coupling piece.

6. The electric nail gun of claim 5, wherein the coupling piece includes a recess, and the elastic piece is formed into an L shape inside the recess.

7. The electric nail gun of claim 1, wherein the gear unit includes a large gear and a small gear coaxially provided and interlocked with each other, and wherein the large gear is meshed with the first rack, and the small gear is meshed with the second rack.

8. The electric nail gun of claim 7, wherein the large gear and the small gear are integrally formed.

9. The electric nail gun of claim 7, wherein the large gear includes at least one first slot, the small gear includes at least one second slot corresponding to the at least one first slot, and the gear unit further includes at least one connecting piece disposed in the respective at least one first slot and the respective at least one second slot, such that the large gear and the small gear are interlocked through the at least one connecting piece.

10. The electric nail gun of claim 9, wherein the at least one first slot and the at least one second slot are curved slots, and the at least one connecting piece is a curved piece.

11. The electric nail gun of claim 9, wherein gaps are formed between the at least one connecting piece and the at least one first slot, the at least one second slot, or both.

12. The electric nail gun of claim 9, wherein the at least one connecting piece is made of an elastic material.
